(19) United States
(12) Patent Application Publication
(10) Pub. No.: US 2025/0164683 A1
(43) Pub. Date: May 22, 2025

(54) Electronic device

(71) Applicant: InnoLux Corporation, Miao-Li County (TW)

(72) Inventors: Wei-Sung LO, Miao-Li County (TW); Shih-Fu LIAO, Miao-Li County (TW); Wei-Cheng LEE, Miao-Li County (TW); I-An YAO, Miao-Li County (TW)

(21) Appl. No.: 18/922,963

(22) Filed: Oct. 22, 2024

Related U.S. Application Data
(60) Provisional application No. 63/602,248, filed on Nov. 22, 2023.

(30) Foreign Application Priority Data
Jun. 20, 2024 (CN) 202410798701.8

(51) Int. Cl. F21V 8/00

(52) U.S. Cl. CPC G02B 6/0036

(57) ABSTRACT

An electronic device includes: a reflective panel; a light guide plate disposed on the reflective panel and having a first surface adjacent to the reflective panel, a second surface and a side surface; and a light source adjacent to the side surface, wherein the second surface includes a recessed structures having a depth, the side surface has a thickness, and a ratio of the depth to the thickness is greater than or equal to 0.0001 and less than or equal to 0.25, wherein after light emitted by the light source, a first light pattern is measured from the first surface, a second light pattern is measured from the second surface, and a maximum ratio of brightness of the first light pattern to brightness of the second light pattern is located at a view angle greater than or equal to 0° and less than or equal to 40°.

### CROSS-REFERENCE TO RELATED APPLICATIONS

This application claims the benefits of the Chinese Patent Application Serial Number 202410798701.8, filed on Jun. 20, 2024, the subject matter of which is incorporated herein by reference.

This application claims the benefit of filing date of U.S. Provisional Application Ser. No. 63/602,248, filed Nov. 22, 2023 under 35 USC § 119(e)(1).

### BACKGROUND

### Field

The present disclosure relates to an electronic device. More specifically, the present disclosure relates to an electronic device comprising a light guide plate with specific designs.

### Description of Related Art

Reflective electronic (display) devices have gradually been widely used in daily life because the back light source can be omitted. In addition, if a bistable cholesteric liquid crystal panel is selected, its power consumption can be greatly reduced, which is beneficial to environmental protection and other advantages.

However, current reflective display devices still have shortcomings such as poor luminous efficiency and glare. Therefore, it is still necessary to develop an electronic device in order to improve the conventional shortcomings.

### SUMMARY

The present disclosure provides an electronic device, which comprises: a reflective panel; a light guide plate disposed on the reflective panel, wherein the light guide plate has a first surface, a second surface opposite to the first surface, and a side surface connecting between the first surface and the second surface, wherein the first surface is adjacent to the reflective panel; and a light source adjacent to the side surface, wherein the second surface comprises a plurality of recessed structures, one of the plurality of recessed structures has a depth in a normal direction of the reflective panel, the side surface has a thickness, and a ratio of the depth to the thickness is greater than or equal to 0.0001 and less than or equal to 0.25; wherein after light emitted by the light source passes through the light guide plate, a first light pattern is measured from the first surface, and a second light pattern is measured from the second surface, wherein a maximum ratio of brightness of the first light pattern to brightness of the second light pattern is located at a view angle greater than or equal to 0° and less than or equal to 40°.

The present disclosure further provides another electronic device, which comprises: a reflective panel; a light guide plate disposed on the reflective panel, wherein the light guide plate has a first surface, a second surface opposite to the first surface, and a side surface connecting between the first surface and the second surface, wherein the first surface is adjacent to the reflective panel; and a light source adjacent to the side surface, wherein the second surface comprises a plurality of recessed structures, one of the plurality of recessed structures has a depth in a normal direction of the reflective panel, the side surface has a thickness, and a ratio of the depth to the thickness is greater than or equal to 0.0001 and less than or equal to 0.25; wherein after light emitted by the light source passes through the light guide plate, a first light pattern is measured from the first surface, a ratio of brightness of the first light pattern at a view angle of 0° to a maximum brightness of the first light pattern ranges from 0.05 to 0.4.

Other novel features of the disclosure will become more apparent from the following detailed description when taken in conjunction with the accompanying drawings.

### BRIEF DESCRIPTION OF DRAWINGS

FIG. 1 is a schematic view showing a part of an electronic device according to one embodiment of the present disclosure.

FIG. 2A is a light pattern measured form a first surface of a light guide plate according to one embodiment of the present disclosure.

FIG. 2B is a light pattern measured from a second surface of a light guide plate according to one embodiment of the present disclosure.

FIG. 3 is a schematic view showing a light guide plate according to one embodiment of the present disclosure.

FIG. 3A and FIG. 3B are respectively enlarged views of FIG. 3.

FIG. 4 is a schematic view showing a part of an electronic device according to one embodiment of the present disclosure.

FIG. 5 is a schematic view showing a part of an electronic device according to one embodiment of the present disclosure.

FIG. 6 is a schematic view showing an electronic device according to one embodiment of the present disclosure.

FIG. 7 is a schematic view showing an electronic device according to one embodiment of the present disclosure.

### DETAILED DESCRIPTION

The following is specific embodiments to illustrate the implementation of the present disclosure. Those who are familiar with this technique can easily understand the other advantages and effects of the present disclosure from the content disclosed in the present specification.

The present disclosure can also be implemented or applied by other different specific embodiments, and various details in the present specification can also be modified and changed according to different viewpoints and applications without departing from the spirit of the present disclosure.

It should be noted that, in the present specification, when a component is described to have an element, it means that the component may have one or more of the elements, and it does not mean that the component has only one of the element, except otherwise specified. Furthermore, the ordinals recited in the specification and the claims such as “first”, “second” and so on are intended only to describe the elements claimed and imply or represent neither that the claimed elements have any proceeding ordinals, nor that sequence between one claimed element and another claimed element or between steps of a manufacturing method. The use of these ordinals is merely to differentiate one claimed element having a certain designation from another claimed element having the same designation.

In the specification and the appended claims of the present disclosure, certain words are used to refer to specific elements. Those skilled in the art should understand that electronic device manufacturers may refer to the same components by different names. The present specification does not intend to distinguish between elements that have the same function but have different names. In the following description and claims, words such as “comprising”, “including”, “containing”, and “having” are open-ended words, so they should be interpreted as meaning “containing but not limited to . . . ”. Therefore, when the terms “comprising”, “including”, “containing” and/or “having” are used in the description of the present disclosure, they specify the existence of corresponding features, regions, steps, operations and/or components, but do not exclude the existence of one or more corresponding features, regions, steps, operations and/or components.

The terms, such as “about”, “substantially”, or “approximately”, are generally interpreted as within 10%, 5%, 3%, 2%, 1%, or 0.5% of a given value or range. The quantity given here is an approximate quantity, that is, without specifying “about”, “approximately”, “substantially” and “approximately”, “about”, “approximately”, “substantially” and “approximately” can still be implied. Furthermore, when a value is “in a range from a first value to a second value” or “in a range between a first value and a second value”, the value can be the first value, the second value, or another value between the first value and the second value.

In the present specification, except otherwise specified, the terms (including technical and scientific terms) used herein have the meanings generally known by a person skilled in the art. It should be noted that, except otherwise specified, in the embodiments of the present disclosure, these terms (for example, the terms defined in the generally used dictionary) should have the meanings identical to those known in the art, the background of the present disclosure or the context of the present specification, and should not be read by an ideal or over-formal way.

In addition, relative terms such as “below” or “under” and “on”, “above” or “over” may be used in the embodiments to describe the relative relationship between one element and another element in the drawings. It will be understood that if the device in the drawing was turned upside down, elements described on the “lower” side would then become elements described on the “upper” side. When a unit (for example, a layer or a region) is referred to as being “on” another unit, it can be directly on the another unit or there may be other units therebetween. Furthermore, when a unit is said to be “directly on another unit”, there is no unit therebetween. Moreover, when a unit is said to be “on another unit”, the two have a top-down relationship in a top view, and the unit can be disposed above or below the another unit, and the top-bottom relationship depends on the orientation of the device.

In the present disclosure, the distance, the width, the length, the thickness and the depth may be measured using an optical microscope or using cross-sectional images in an electron microscope, but the present disclosure is not limited thereto. In addition, any two values or directions used for comparison may have certain errors. If the first value is equal to the second value, it implies that there may be an error of about 10% between the first value and the second value. If the first direction is perpendicular to the second direction, the angle between the first direction and the second direction may be between 80° and 100°. If the first direction is parallel to the second direction, the angle between the first direction and the second direction may be between 0° and 10°.

It should be noted that the technical solutions provided in different embodiments below can be replaced, combined or mixed with each other to constitute another embodiment without violating the spirit of the present disclosure.

The electronic device of the present disclosure may include, for example, a display device, a sensing device, an antenna device, a touch device, a tiled device or other suitable electronic devices; but the present disclosure is not limited thereto. The display device of the present disclosure may be a non-self-luminous display device or a self-luminous display device, such as a liquid crystal display, a cholesteric liquid crystal display, an electro-phoretic display, an organic light emitting diode display or a light emitting diode display; but the present disclosure is not limited thereto. The display device may comprise a light emitting diode, a light conversion layer, other suitable materials or a combination thereof; but the present disclosure is not limited thereto. The light emitting diode may comprise, for example, an organic light emitting diode (OLED), a mini light emitting diode (mini LED), a micro light emitting diode (micro LED) or a quantum dot light emitting diode (quantum dot LED which may include QLED or QDLED); but the present disclosure is not limited thereto. The light conversion layer may comprise wavelength conversion materials and/or filter materials. The light conversion layer may comprise, for example, fluorescence, phosphors, quantum dots (QDs), other suitable materials or a combination thereof; but the present disclosure is not limited thereto. The sensing device may include, for example, a biosensor, a touch sensor, a fingerprint sensor, other suitable sensors or a combination of the above types of sensors. The antenna device may, for example, be a liquid crystal antenna or other types of antenna; but the present disclosure is not limited thereto. The tiled device may, for example, be a tiled display device or a tiled antenna device; but the present disclosure is not limited thereto. The electronic device may comprise an electronic unit, which may comprise a passive component, an active component or a combination thereof, such as a capacitor, a resistor, an inductor, a varactor diode, a variable capacitor, a filter, a diode, a transistor, a sensor, a microelectromechanical system (MEMS), or a chip; but the present disclosure is not limited thereto. It should be noted that the electronic device of the present disclosure may be any combination of the above devices; but the present disclosure is not limited thereto.

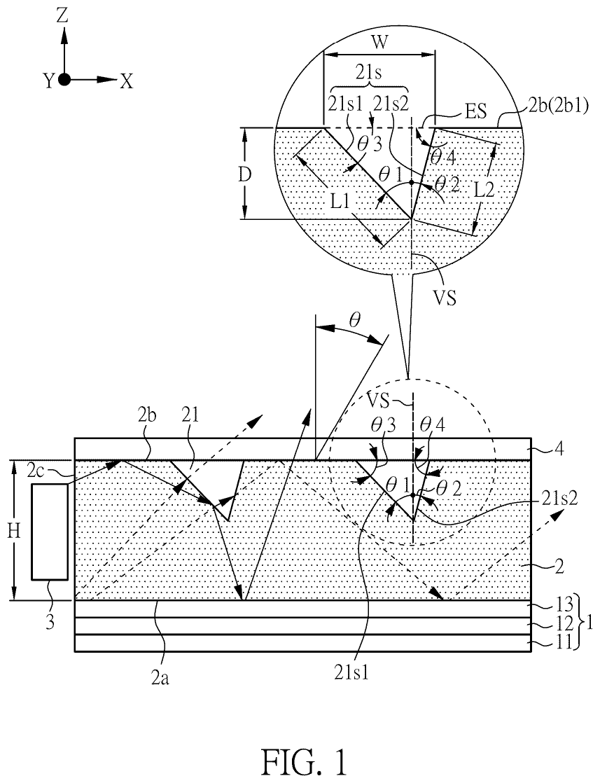

FIG. 1 is a schematic view showing a part of an electronic device according to one embodiment of the present disclosure.

In one embodiment of the present disclosure, as shown in FIG. 1, the electronic device may comprise: a reflective panel 1; a light guide plate 2 disposed on the reflective panel 1, wherein the light guide plate 2 has a first surface 2a, a second surface 2b opposite to the first surface 2a and a side surface 2c connecting between the first surface 2a and the second surface 2b, wherein the first surface 2a is adjacent to the reflective panel 1; and a light source 3 adjacent to the side surface 2c. The second surface 2b comprises a plurality of recessed structures 21, one of the recessed structures 21 has a depth D in a normal direction Z of the reflective panel 1, the side surface 2c has a thickness H, and a ratio of the depth D to the thickness H is greater than or equal to 0.0001 and less than or equal to 0.25, but the present disclosure is not limited thereto. In some embodiments, the ratio of the depth D to the thickness H is greater than or equal to 0.001 and less than or equal to 0.1. In some embodiments, the ratio of the depth D to the thickness H may be greater than or equal to 0.002 and less than or equal to 0.05. In some embodiments, the ratio of the depth D to the thickness H may be greater than or equal to 0.003 and less than or equal to 0.02. Through the above design, the light guide efficiency of the light guide plate 2 (for example, the light guide efficiency that the light is guided to the reflective panel 1) may be improved.

In one embodiment of the present disclosure, as shown in FIG. 1, the reflective panel 1 may comprise a first panel 11, a second panel 12 and a third panel 13, and the second panel 12 is disposed between the first panel 11 and the third panel 13. The first panel 11, the second panel 12 and the third panel 13 may selectively reflect light with different colors respectively. The cholesteric liquid crystal layers in the first panel 11, the second panel 12 and the third panel 13 may be, for example, used to reflect light with different colors respectively in a planer state. For example, the cholesteric liquid crystal layer in the first panel 11 may reflect blue light in the planer state, the cholesteric liquid crystal layer in the second panel 12 may reflect green light in the planer state, and the cholesteric liquid crystal layer in the third panel 13 may reflect red light in the planer state; but the present disclosure is not limited thereto.

In the present disclosure, the material of the light guide plate 2 may comprise glass, polycarbonate (PC), polymethylmethacrylate (PMMA), polyethylene terephthalate (PET), suitable high light transmitting material or a combination thereof; but the present disclosure is not limited thereto. In one embodiment, the thickness H of the light guide plate 2 (for example, the thickness H of the side surface 2c) may be between 120 μm and 5000 μm (120 μm≤H≤5000 μm), for example, between 200 μm and 4000 μm (200 μm≤H≤4000 μm), between 300 μm and 3000 μm (300 μm≤H≤3000 μm) or between 400 μm and 2000 μm (400 μm≤H≤2000 μm); but the present disclosure is not limited thereto.

In one embodiment of the present disclosure, as shown in FIG. 1, the recessed structures 21 may respectively have a concave surface 21s connecting to a planar surface 2b1 of the second surface 2b. In a cross-section of the light guide plate 2, the concave surface 21s comprises a first side 21s1 (for example, the side adjacent to the light source) and a second side 21s2 (for example, the side facing away from the light source), and an angle included between the first side 21s1 and a virtual surface VS perpendicular to the planar surface 2b1 is a first angle θ1, an angle included between the second side 21s2 and the virtual surface VS is a second angle θ2, and the first angle θ1 is greater than the second angle θ2. Through the above design, the light guide efficiency of the light guide plate 2 can be improved. In one embodiment of the present disclosure, as shown in FIG. 1, an angle included between the first side 21s1 and an extension surface ES of the planar surface 2b1 is a third angle θ3, an angle included between the second side 21s2 and the extension surface ES is a fourth angle θ4, and the third angle θ3 is less than the fourth angle θ4. Through the above design, the efficiency of the light guide plate 2 to guide light downward to the reflective panel 1 can be improved. In one embodiment of the present disclosure, as shown in FIG. 1, the planar surface 2b1 may be approximately perpendicular to the normal direction Z of the light guide plate 2; but the present disclosure is not limited thereto.

In the present disclosure, when observing from the top view direction of the light guide plate 2, the shape of the recessed structure 21 may comprise, for example, circle, oval, half-moon, rectangle, rhombus, polygon, irregular shape or other suitable shapes; but the present disclosure is not limited thereto. In one embodiment of the present disclosure, the depth D of the recessed structure 21 may be between 0.5 μm and 30 μm (0.5 μm≤D≤30 μm), for example, between 1 μm and 25 μm (1 μm≤D≤25 μm), between 1.5 μm and 20 μm (1.5 μm≤D≤20 μm) or between 2 μm and 10 μm (2 μm≤D≤10 μm); but the present disclosure is not limited thereto. In the present disclosure, the “depth of the recessed structure” refers to, for example, the maximum distance between the recessed structure 21 and the extension surface ES of the planar surface 2b1 of the second surface 2b in the normal direction Z of the light guide plate 2. In one embodiment of the present disclosure, the ratio of the depth D of the recessed structure 21 to the thickness H of the side surface 2c may be between 0.0001 and 0.25 (0.0001≤D/H≤0.25), for example, between 0.00025 and 0.125 (0.00025≤D/H≤0.125), between 0.0005 and 0.0667 (0.0005≤D/H≤0.0667) or between 0.0008 and 0.05 (0.0008≤D/H≤0.05); but the present disclosure is not limited thereto. When the ratio of the depth D of the recessed structure 21 to the thickness H of the side surface 2c meets the aforesaid design, the light guide efficiency of the light guide plate 2 can be improved.

In one embodiment of the present disclosure, the width W of the recessed structure 21 may be between 5 μm and 150 μm (5 μm≤W<150 μm), for example, between 8 μm and 120 μm (8 μm≤W<120 μm), between 10 μm and 100 μm (10 μm≤W<100 μm) or between 15 μm and 80 μm (15 μm≤W<80 μm); but the present disclosure is not limited thereto. The “width of the recessed structure” refers to, for example, the distance between adjacent planar surfaces 2b1 in a cross-section of the light guide plate 2; or a maximum width of the recessed structure in the first direction X. In one embodiment of the present disclosure, a ratio of the depth D of the recessed structure 21 to the width W of the recessed structure 21 may be between 0.003 and 6 (0.003≤D/W≤6), for example, between 0.008 and 3.125 (0.008≤D/W≤3.125), between 0.015 and 2 (0.015≤D/W≤2), between 0.025 and 1.5 (0.025≤D/W≤1.5) or between 0.03 and 1 (0.03≤D/W≤1); but the present disclosure is not limited thereto. In one embodiment of the present disclosure, as shown in FIG. 1, the first side 21s1 has a first length L1, the second side 21s2 has a second length L2, and a ratio of the first length L1 to the second length L2 may be greater than 1 and less than or equal to 8 (1≤L1/L2≤8), greater than 1 and less than or equal to 6 (1≤L1/L2≤6) or greater than 1 and less than or equal to 4 (1≤L1/L2≤4); but the present disclosure is not limited thereto. When the design of the recessed structure 21 meets one or more of the aforesaid requirements, the light guide efficiency of the light guide plate 2 can be improved. The “first/second length” refers to, for example, a distance from one end of the first side 21s1/second side 21s2 adjacent to the planar surface 2b1 to another end thereof far away from the planar surface 2b1 in the cross-section of the light guide plate 2. In some embodiments, the first side 21s1 and the second side 21s2 may be curved, but the present disclosure is not limited thereto.

In the present disclosure, the light source 3 may comprise light emitting diodes (LEDs), and the light emitting diodes may comprise, for example, organic light emitting diodes (OLED), mini LEDs, micro LEDs or quantum dot LEDs (including QLEDs or QDLEDs), fluorescence, phosphors, other suitable material or a combination thereof; but the present disclosure is not limited thereto.

In one embodiment of the present disclosure, the electronic device may comprise an adhesion unit 4 disposed on the light guide plate 2. The material of the adhesion unit 4 may comprise polyvinyl butyral (PVB), ethylene vinyl acetate (EVA), optical clear adhesive (OCA), optical clear resin (OCR), other suitable material of a combination thereof; but the present disclosure is not limited thereto. In the present disclosure, the refractive index (n) of the adhesion unit 4 may be between 1 and 1.4 (1≤n≤1.4) or between 1 and 1.35 (1≤n≤1.35); but the present disclosure is not limited thereto. In the following, the light patterns of the first surface 2a and the second surface 2b are measured in to one embodiment of the present disclosure that the recessed structure 21 of the light guide plate 2 has different angles (for example, the first angle θ1 and the second angle θ2), to discuss the light guide effect of the light guide plate 2. In addition, the measurement positions of the light patterns are approximately at the centers of the first surface 2a and the second surface 2b respectively. The light pattern can be determined by an angle analyzer (such as model DMS-803, but not limited to this), an imaging spectrocolorimeter (such as Conometer), or other machines with similar functions; but the present disclosure is not limited thereto. In one embodiment, when measuring the first surface 2a or the second surface 2b of the light guide plate 2, an adhesion unit (for example, optical glue) may be or not be formed thereon, so the adhesion unit has little impact on the light pattern. The light pattern may comprise azimuth angle ψ and tilt angle θ. The azimuth angle ψ has a range of 0 degrees to 360 degrees. The azimuth angle ψ is, for example, the angle corresponding to different directions on the planer surface of the first surface 2a or the second surface 2b of the light guide plate 2. For example, the location adjacent to the light source 3 may be defined as the azimuth angle ψ of 270 degrees, while the location far away from the light source 3 may be defined as an azimuth angle ψ of 90 degrees. The tilt angle θ is defined as the angle inclined to the first surface 2a or the second surface 2b. The tilt angle θ of 0 degrees represents the direction parallel to the normal of the first surface 2a or the second surface 2b, and the tilt angle θ of 90 degrees represents the direction parallel to the first surface 2a or the second surface 2b, and so on.

In one embodiment of the present disclosure, the light patterns are measured on the first surface 2a of the light guide plate 2 having the recessed structure 21 with different angles (for example, the first angle θ1 and the second angle θ2), and L % is calculated using the following equation (1) to obtain the luminance (L %) of each angle combinations, as shown in Table 1.

$$L \% = L / {L}_{max} \qquad Equation ( 1 )$$

Herein, L is the brightness measured at the view angle (θ) of 0°; and Lₘₐₓ is the maximum brightness measured at the view angle (θ) between 00 and 60°.

TABLE 1
Luminance (L %)

| | θ1 | | | | | | | |
|---|---|---|---|---|---|---|---|---|
| θ2 | 40° | 45° | 50° | 55° | 60° | 65° | 70° | 75° |
| 0° | 100% | 100% | 40% | 11% | 5% | 4% | 1% | 1% |
| 5° | | | | | | | | |
| 10° | | | | | | | | |
| 15° | | 100% | 40% | | 5% | | 1% | |
| 20° | | | | | 6% | 5% | | |
| 25° | | | | 8% | | 6% | | |
| 30° | | 100% | 39% | 11% | 7% | 6% | | |
| 35° | | | | | | | | |
| 40° | | | | 11% | | | | |
| 45° | | 28% | | | | | | |
| 50° | | | 40% | | | | | |
| 55° | | | | | | | | |
| 60° | | | | | 6% | | | |
| 65° | | 15% | | 13% | | 6% | 1% | 1% |

When L % is greater than 40%, it means that the electronic device is prone to glare at a positive view angle; when L % is less than 5%, it means that the brightness of the electronic device at a positive view angle is too dark. Thus, when the light emitting from the light source 3 passes through the light guide plate 2, in the first light pattern measured from the first surface 2a, a ratio of the brightness at 0° view angle (0=0°) to the maximum brightness is between 0.05 and 0.4, i.e. L % is between 5% and 40% (5%≤L %≤40%), the design of the corresponding recessed structure 21 can make the light guide plate 2 have better light guide effect (the effect of guiding light to the reflective panel 1). In addition to maintaining the appropriate brightness of the positive view angle, it can also improve or reduce glare.

In one embodiment of the present disclosure, the light patterns are measured on the first surface 2a and the second surface 2b of the light guide plate 2 having the recessed structure 21 with different angles (for example, the first angle θ1 and the second angle θ2) respectively, and the view angle (θ) range corresponding to the maximum ratio of the center brightness of the first surface 2a to the center brightness of the second surface 2b (i.e. the center brightness of the first surface 2a/the center brightness of the second surface 2b) is calculated. Each angle combinations can be obtained, as shown in Table 2.

TABLE 2
View angle (θ)

θ1

| θ2 | 40° | 45° | 50° | 55° | 60° | 65° | 70° | 75° |
|---|---|---|---|---|---|---|---|---|
| 0° | 0° | 0° | 20° | 10° | 20° | 20° | 40° | 50° |
| 5° | | | | | | | | |
| 10° | | | | | | | | |
| 15° | | 0° | 0° | | 20° | | 40° | |
| 20° | | | | | 20° | 40° | | |
| 25° | | | | 10° | | 40° | | |
| 30° | | 0° | 20° | 30° | 20° | 40° | | |
| 35° | | | | | | | | |
| 40° | | | | 30° | | | | |
| 45° | | 10° | | | | | | |
| 50° | | | 20° | | | | | |
| 55° | | | | | | | | |
| 60° | | | | | 20° | | | |
| 65° | | 10° | | 30° | | 40° | 40° | 50° |

When the maximum ratio of the center brightness of the first surface 2a to the center brightness of the second surface 2b (i.e. the center brightness of the first surface 2a/the center brightness of the second surface 2b) corresponds to the view angle (θ) ranging from 0° to 40°, it means that the electronic device has better luminous efficiency at a general view angle (the view angle (θ) is between 0° and 40°). Thus, when light emitting from the light source 3 penetrates through the light guide plate 2, the first light pattern is measured from the first surface 2a, the second light pattern is measured from the second surface 2b, and a maximum ratio of the brightness of the first light pattern to the brightness of the second light pattern is located at a view angle (θ) greater than or equal to 0° and less than or equal to 40°. That is, when the maximum ratio of the center brightness of the first surface 2a to the center brightness of the second surface 2b (i.e. the center brightness of the first surface 2a/the center brightness of the second surface 2b) corresponds to the view angle (θ) ranging from 0° to 40°, the design of the corresponding recessed structure 21 can make the light guide plate 2 have better light guide effect. Because the light emitting from the second surface 2b is not used to provide light reflected by the reflective panel 1 and the light emitting from the first surface 2a is used to provide light reflected by the reflective panel 1, the maximum ratio of the center brightness of the first surface 2a to the center brightness of the second surface 2b (i.e. the center brightness of the first surface 2a/the center brightness of the second surface 2b) is designed to correspond to the view angle (θ) between 0° and 40° to have better light guide effect to ensure higher brightness at the view angle (θ) ranging from 0° to 40°. In other words, by the matching design of the first angle θ1 and the second angle θ2 of the recessed structure 21, the maximum ratio of the center brightness of the first surface 2a to the center brightness of the second surface 2b (i.e. the center brightness of the first surface 2a/the center brightness of the second surface 2b) can correspond to the view angle (θ) ranging from 0° to 40°, and the light guide plate 2 with this design may have better light guide effect, ensuring higher brightness at the view angle (θ) ranging from 0° to 40°.

In one embodiment of the present disclosure, the light patterns are measured on the first surface 2a and the second surface 2b of the light guide plate 2 having the recessed structure 21 with different angles (for example, the first angle θ1 and the second angle θ2), and the luminance of the first surface 2a and the second surface 2b is calculated using the following equation (2) to obtain the luminance of each angle combinations, as shown in Table 3.

Luminance=L₂ₐ/L_{2b} Equation (2):

Herein, L₂ₐ is the average brightness measured from the first surface 2a at the view angle (θ) ranging from 10° to 30°; and L_{2b} is the average brightness measured from the second surface 2b at the view angle (θ) ranging from 10° to 30°. The “average brightness” refers to, for example, the result obtained by measuring the brightness at the view angles of 10°, 20° and 30° respectively and averaging the obtained three values.

TABLE 3
Luminance

θ1

| θ2 | 40° | 45° | 50° | 55° | 60° | 65° | 70° | 75° |
|---|---|---|---|---|---|---|---|---|
| 0° | 3 | 10 | 21 | 28 | 32 | 81 | 101 | 135 |
| 5° | | | | | | | | |
| 10° | | | | | | | | |
| 15° | | 13 | 23 | | 37 | | 100 | |
| 20° | | | | | 41 | 64 | | |
| 25° | | | | 31 | | 65 | | |
| 30° | | 7 | 10 | 14 | 21 | 32 | | |
| 35° | | | | | | | | |
| 40° | | | | 5 | | | | |
| 45° | | 4 | | | | | | |
| 50° | | | 3 | | | | | |
| 55° | | | | | | | | |
| 60° | | | | | 6 | | | |
| 65° | | 1 | | 2 | | 5 | 7 | 13 |

The light emitting from the second surface 2b is not used to provide light reflected by the reflective panel 1 and the light emitting from the first surface 2a is used to provide light reflected by the reflective panel 1, so when the ratio of the brightness of the first surface 2a to the brightness of the second surface 2b is larger, the light that the light guide plate 2 can provide is more. Thus, the light guide efficiency of the light guide plate 2 can be increased, and higher brightness can be obtained at the view angle (θ) ranging from 10° to 30°. Thus, when light emitting from the light source 3 passes through the light guide plate 2, the first light pattern is measured from the first surface 2a, the second light pattern is measured from the second surface 2b, and a ratio of the brightness of the first light pattern to the brightness of the second light pattern is greater than or equal to 5 at the view angle between 10° and 30°. In this case, the corresponding design of the recessed structure 21 can make the light guide plate 2 have better light guide effect. In other words, by matching design of the first angle θ1 and the second angle θ2 of the recessed structure 21, the ratio of the brightness of the first surface 2a to the brightness of the second surface 2b can be greater than or equal to 5; and at this time, the light guide plate 2 may have better light guide effect to ensure higher brightness at the view angle (θ) ranging from 10° to 30°.

According to the results shown in Table 1 to Table 3, in one embodiment of the present disclosure, the concave surface 21s comprises a first side 21s1 and a second side 21s2, an angle included between the first side 21s1 and a virtual surface VS perpendicular to the planar surface 2b1 is the first angle θ1, an angle included between the second side 21s2 and the virtual surface VS is the second angle θ2, and the first angle θ1 is greater than the second angle θ2. In one embodiment of the present disclosure, the first angle θ1 may be greater than or equal to 45° and less than or equal to 70° (45°≤θ1≤70°); but the present disclosure is not limited thereto. In other embodiments, the first angle θ1 may be greater than or equal to 45° and less than or equal to 65° (45°≤θ1≤65°). In other embodiments, the first angle θ1 may be greater than or equal to 45° and less than or equal to 60° (45°≤θ1≤60°). In one embodiment of the present disclosure, the second angle θ2 may be greater than or equal to 0° and less than or equal to 45° (0°<θ2≤45°); but the present disclosure is not limited thereto. In other embodiments, the second angle θ2 may be greater than or equal to 0° and less than or equal to 40° (0°≤θ2≤40°). In other embodiments, the second angle θ2 may be greater than or equal to 0° and less than or equal to 35° (0°≤θ2≤35°). In one embodiment of the present disclosure, a sum of the first angle θ1 and the second angle θ2 may be greater than or equal to 50° and less than or equal to 115° (50°≤θ1+θ2≤115°); but the present disclosure is not limited thereto. In other embodiments, the sum of the first angle θ1 and the second angle θ2 may be greater than or equal to 600 and less than or equal to 105° (60°≤θ1+θ2≤105°). In other embodiments, the sum of the first angle θ1 and the second angle θ2 may be greater than or equal to 65° and less than or equal to 100° (65°≤θ1+θ2≤100°). When the first angle θ1 and the second angle θ2 meets the aforesaid designs, the light guide efficiency of the light guide plate 2 can be improved.

In one embodiment of the present disclosure, as shown in FIG. 1, the recessed structures 21 respectively have a concave surface 21s connecting to a planar surface 2b1 of the second surface 2b. In a cross-section of the light guide plate 2, the concave surface 21s comprises a first side 21s1 and a second side 21s2, an angle included between the first side 21s1 and an extension surface ES of the planar surface 2b1 is the third angle θ3, an angle included between the second side 21s2 and the extension surface ES is the fourth angle θ4, and the third angle θ3 is less than the fourth angle θ4. In one embodiment of the present disclosure, the third angle θ3 may be greater than or equal to 20° and less than or equal to 450 (200<03<45°); but the present disclosure is not limited thereto. In other embodiments, the third angle θ3 may be greater than or equal to 250 and less than or equal to 400 (25°≤θ3≤40°). In other embodiments, the third angle θ3 may be greater than or equal to 30° and less than or equal to 35° (30°≤θ3≤35°). In one embodiment of the present disclosure, the fourth angle θ4 may be greater than or equal to 45° and less than or equal to 90° (45°≤θ4≤90°); but the present disclosure is not limited thereto. In other embodiments, the fourth angle θ4 may be greater than or equal to 50° and less than or equal to 85° (50°≤θ4≤85°). In other embodiments, the fourth angle θ4 may be greater than or equal to 55° and less than or equal to 80° (55°≤θ4≤80°). In other embodiments, the fourth angle θ4 may be greater than or equal to 60° and less than or equal to 75° (60°≤θ4≤75°). In one embodiment of the present disclosure, the sum of the third angle θ3 and the fourth angle θ4 may be greater than or equal to 65° and less than or equal to 130° (65°≤θ3+θ4≤130°); but the present disclosure is not limited thereto. In other embodiments, the sum of the third angle θ3 and the fourth angle θ4 may be greater than or equal to 75° and less than or equal to 120° (75°≤θ3+θ4≤120°); but the present disclosure is not limited thereto. In other embodiments, the sum of the third angle θ3 and the fourth angle θ4 may be greater than or equal to 85° and less than or equal to 110° (85°≤θ3+θ4≤110°). When the third angle θ3 and the fourth angle θ4 meet the aforesaid design, the light guide efficiency of the light guide plate 2 can be improved.

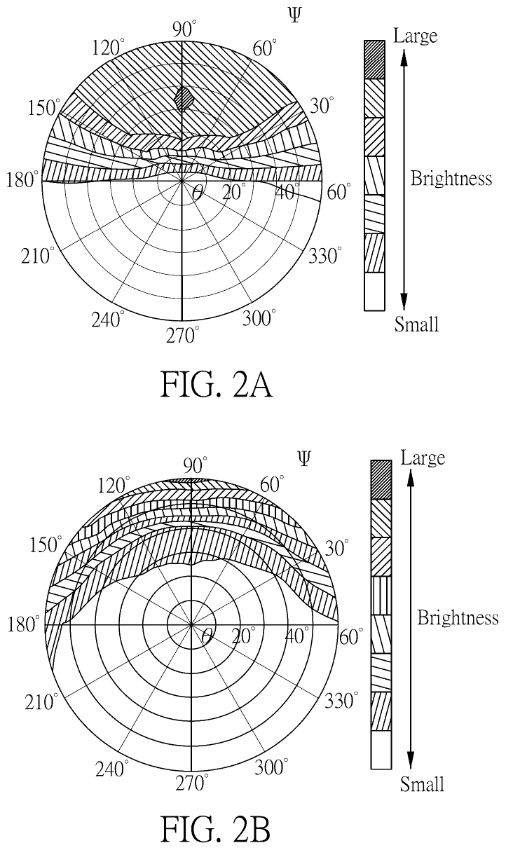

FIG. 2A is a light pattern measured form a first surface of a light guide plate according to one embodiment of the present disclosure. FIG. 2B is a light pattern measured from a second surface of a light guide plate according to one embodiment of the present disclosure.

In one embodiment of the present disclosure, the first surface 2a and the second surface 2b are measured to obtain the first light pattern shown in FIG. 2A and the second light pattern shown in FIG. 2B respectively. Herein the light source 3 is approximately disposed at the position where Y is 270°.

In one embodiment of the present disclosure, as shown in FIG. 2A and FIG. 2B, in the first light pattern, a maximum brightness can be obtained when the view angle (θ) is between 0° and 40° or between 20° and 40°. In the second light pattern, a maximum brightness can be obtained when the view angle (θ) is greater than 40°, for example between 50° and 60°; but the present disclosure is not limited thereto. In addition, in the first light pattern, a ratio of the brightness at 0° view angle (0=0°) to the maximum brightness may be, for example, between 0.05 and 0.4 (for example, the said ratio may be 0.1, 0.2 or 0.3). The maximum ratio of the brightness of the first light pattern to the brightness of the second light pattern is located at the view angle greater than or equal to 0° and less than or equal to 40°, for example at the position that the view angle (θ) is 20° or 30°. At the view angle (θ) between 10° and 30°, the ratio of the brightness of the first light pattern to the brightness of the second light pattern may be, for example, greater than or equal to 5, and for example, the said ratio may be 5.2, 6.3 or other values.

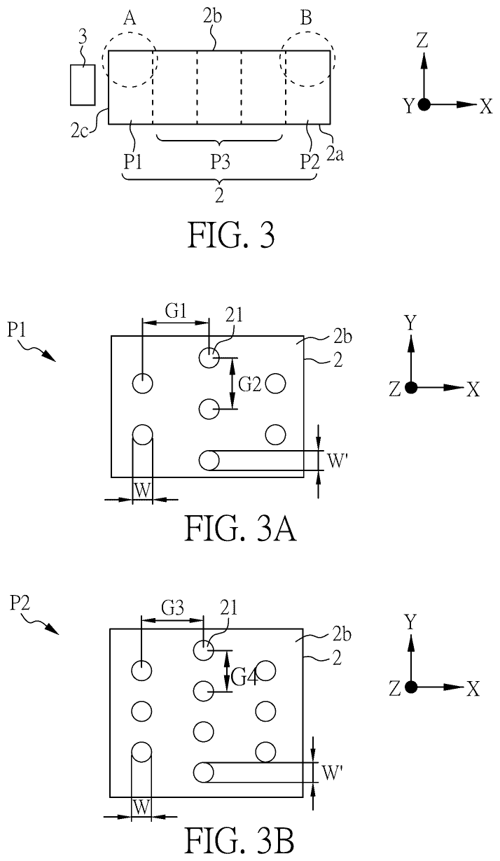

FIG. 3 is a schematic view showing a light guide plate according to one embodiment of the present disclosure. FIG. 3A and FIG. 3B are respectively enlarged views of FIG. 3. Herein, FIG. 3 is a cross-sectional schematic view of a light guide plate, FIG. 3A is a top schematic view of the A portion of FIG. 3, and FIG. 3B is a top schematic view of the B portion of FIG. 3.

In one embodiment of the present disclosure, as shown in FIG. 3, the light guide plate 2 may comprise a first part P1, a second part P2 and a third part P3, and the third part P3 locates between the first part P1 and the second part P2. Compared to the second part P2 and the third part P3, the first part P1 is adjacent to the light source 3. Compared to the first part P1 and the third part P3, the second part P2 is away from the light source 3. In one embodiment of the present disclosure, the first part P1 is a part of the light guide plate 2 closest to the side surface 2c, and the third part P3 may be a part of the light guide plate 2 farthest from the side surface 2c. In one embodiment of the present disclosure, as shown in FIG. 3, the third part P3 may further comprise a plurality of sub-parts, and for example, three sub-parts are used as an example in FIG. 3; but the present disclosure is not limited thereto.

In one embodiment of the present disclosure, when observing from the top view direction (for example, the Z direction) of the light guide plate 2, the density of the recessed structures 21 adjacent to the light source 3 may be less than the density of the recessed structures 21 away from the light source 3. As shown in FIG. 3A and FIG. 3B, when observing from the top view direction (for example, the Z direction) of the light guide plate 2, the density of the recessed structures 21 in the first part P1 of the light guide plate 2 is less than the density of the recessed structures 21 in the second part P2 of the light guide plate 2, or the density of the recessed structures 21 in the first part P1 of the light guide plate 2 is less than the density of the recessed structures 21 in the third part P3 of the light guide plate 2. In one embodiment of the present disclosure, a gap of adjacent recessed structures 21 adjacent to the light source 3 may be greater than a gap of adjacent recessed structures 21 away from the light source 3. More specifically, as shown in FIG. 3A and FIG. 3B, in the first part P1 of the light guide plate 2, a first gap G1 is between adjacent recessed structures 21 in the first direction X, and a second gap G2 is between adjacent recessed structures 21 in the second direction Y. In the second part P2 of the light guide plate 2, a third gap G3 is between adjacent recessed structures 21 in the first direction X, and a fourth gap G4 is between adjacent recessed structures 21 in the second direction Y. For example, the first gap G1 is greater than the third gap G3, and/or the second gap G2 is greater than the fourth gap G4. The “gap” refers to, for example, a distance between adjacent recessed structures 21 in the first direction X and/or the second direction Y. In the present disclosure, a distance between adjacent recessed structures 21 may be, for example, measured by the distance between approximate centers of adjacent recessed structures 21, or for example, measured by the distance between the same sides of adjacent recessed structures 21. In one embodiment of the present disclosure, in the first direction X, the first gap G1 and/or the second gap G2 may be greater than the maximum width W of one recessed structure 21. In one embodiment (not shown in the figure), in first direction X, the first gap G1 and/or the second gap G2 may be less than or equal to the maximum width W of one recessed structure 21. In one embodiment of the present disclosure, in the second direction Y, the third gap G3 and/or the fourth gap G4 may be greater than the width W′ of one recessed structure 21. In one embodiment (not shown in the figure), in the second direction Y, the third gap G3 and/or the fourth gap G4 may be less than or equal to the width W′ of one recessed structure 21.

FIG. 4 is a schematic view showing a part of an electronic device according to one embodiment of the present disclosure. The electronic device shown in FIG. 4 is similar to that shown in FIG. 1, except for the following differences.

In one embodiment of the present disclosure, as shown in FIG. 4, the light guide plate 2 comprises a first surface 2a, a second surface 2b, a side surface 2c and a side surface 2d, wherein the first surface 2a is opposite to the second surface 2b, the side surface 2c is opposite to the side surface 2d, the side surface 2c and the side surface 2d respectively connect between the first surface 2a and the second surface 2b, the side surface 2c is adjacent to the light source 3, and the side surface 2d is away from the light source 3; but the present disclosure is not limited thereto. The side surface 2c has a thickness H1, and the side surface 2d has a thickness H2, wherein the thickness H1 is greater than or equal to the thickness H2. In one embodiment of the present disclosure, as shown in FIG. 4, the thickness H1 may be greater than the thickness H2; but the present disclosure is not limited thereto. In one embodiment of the present disclosure, as shown in FIG. 4, the planar surface 2b1 of the second surface 2b may not be perpendicular to the normal direction Z of the light guide plate 2; and that is, an angle included between the planar surface 2b1 and the normal direction Z of the light guide plate 2 may not be 90°; but the present disclosure is not limited thereto. In other embodiments (not shown in the figure), except for the light source 3 adjacent to the side surface 2c, another light source (not shown in the figure) adjacent to the side surface 2d may be included. In one embodiment of the present disclosure, the depth D of the recessed structure 21 refers to, for example, in the cross-section of the light guide plate 2, a maximum vertical distance between the recessed structure 21 and the planar surface 2b1 or the extension surface ES. In the present disclosure, a ratio of the depth D of the recessed structure 21 to the thickness H1 of the side surface 2c of the light guide plate 2 may be greater than or equal to 0.0001 and less than or equal to 0.25 (0.0001≤D/H1≤0.25); but the present disclosure is not limited thereto. In some embodiments, the ratio of the depth D to the thickness H1 may be greater than or equal to 0.001 and less than or equal to 0.1 (0.001≤D/H1≤0.1). In some embodiments, the ratio of the depth D to the thickness H1 may be greater than or equal to 0.002 and less than or equal to 0.05 (0.002≤D/H1<0.05). In some embodiments, the ratio of the depth D to the thickness H1 may be greater than or equal to 0.003 and less than or equal to 0.02 (0.003≤D/H1≤0.02). Through the above design, the light guide efficiency of the light guide plate 2 can be improved.

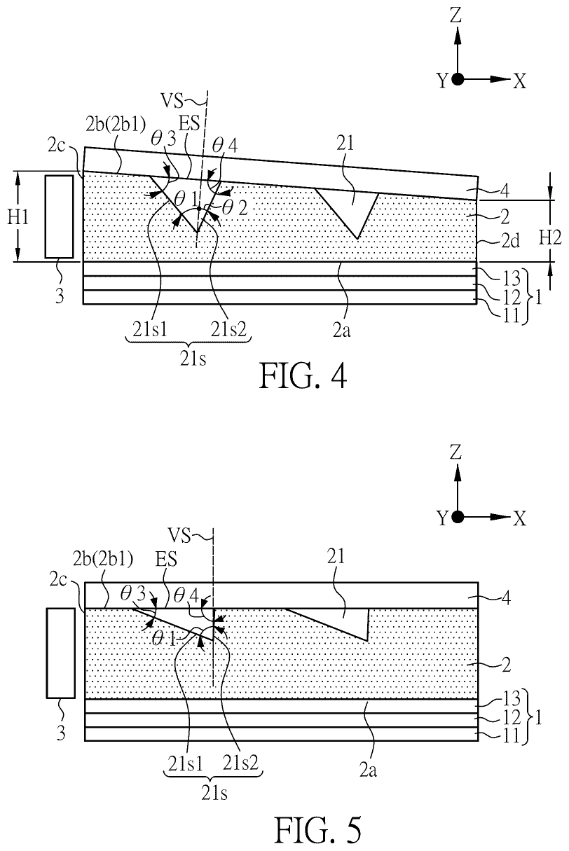

FIG. 5 is a schematic view showing a part of an electronic device according to one embodiment of the present disclosure. The electronic device shown in FIG. 5 is similar to that shown in FIG. 1, except for the following differences.

In one embodiment of the present disclosure, as shown in FIG. 5, the recessed structures 21 respectively have a concave surface 21s connecting to the planar surface 2b1 of the second surface 2b. In the cross-section of the light guide plate 2, the concave surface 21s comprises a first side 21s1 and a second side 21s2, an angle included between the first side 21s1 and a virtual surface VS perpendicular to the planar surface 2b1 is the first angle θ1, and an angle included between the second side 21s2 and the virtual surface VS is the second angle θ2. In the present disclosure, as shown in FIG. 5, the second side 21s2 is substantially parallel to the virtual surface VS, so the second angle θ2 may be considered as 0°; but the present disclosure is not limited thereto.

In one embodiment of the present disclosure, as shown in FIG. 5, an angle included between the first side 21s1 and the extension surface ES is the third angle θ3, and an angle included between the second side 21s2 and the extension surface ES is the fourth angle θ4. In the present disclosure, as shown in FIG. 5, the second side 21s2 is substantially perpendicular to the extension surface ES, so the fourth angle θ4 may be considered as 90°; but the present disclosure is not limited thereto.

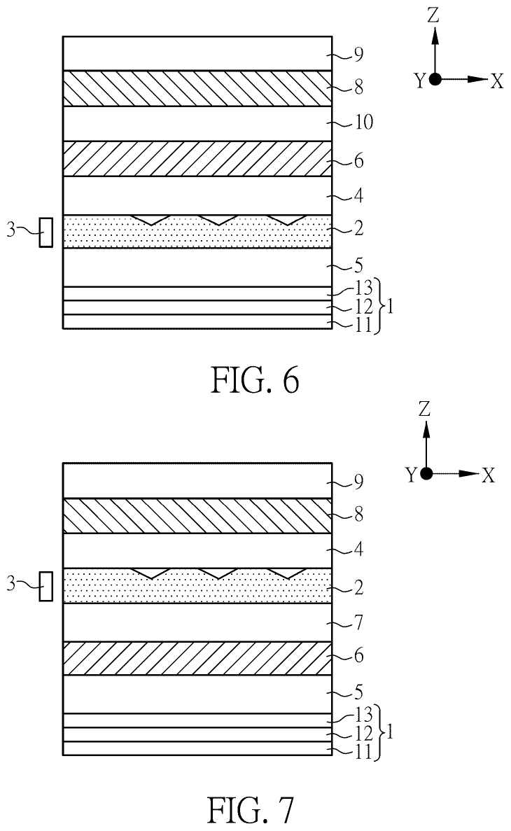

FIG. 6 is a schematic view showing an electronic device according to one embodiment of the present disclosure.

In one embodiment of the present disclosure, as shown in FIG. 6, the electronic device may comprise: a reflective panel 1; a light guide plate 2 disposed on the reflective panel 1; a light source 3 disposed adjacent to the light guide plate 2; an adhesion unit 5 disposed between the light guide plate 2 and the reflective panel 1; a touch layer 6 disposed on the light guide plate 2, wherein the light guide plate 2 is disposed between the reflective panel 1 and the touch layer 6; an adhesion unit 4 disposed between the light guide plate 2 and the touch layer 6; a cover substrate 8 disposed on the touch layer 6; and an adhesion unit 10 disposed between the cover substrate 8 and the touch layer 6; but the present disclosure is not limited thereto. By combining with the touch layer 6, the electronic device of the present disclosure may be, but is not limited to, for example, a touch display device. In other embodiments, the touch layer 6 and/or the adhesion unit 10 may be omitted; but the present disclosure is not limited thereto. The adhesion unit 4 may comprise, for example, a single layer structure or a multi-layer structure.

In the present disclosure, the reflective panel 1, the light source 3 and the adhesion unit 4 may be as described above, and are not described here again. In the present disclosure, the light guide plate 2 may be, for example, any one shown in FIG. 1 and FIG. 3 to FIG. 5, and is not described here again. In some disclosures, the loss tangent (tan δ) of the adhesion unit 4 at 30° C. is greater than 0 and less than or equal to 5; but the present disclosure is not limited thereto. In some disclosures, the loss tangent (tan δ) of the adhesion unit 4 at 30° C. is greater than 0 and less than or equal to 4; but the present disclosure is not limited thereto. The adhesion unit 4 may be, for example, an adhesion unit contacting the second surface 2b of the light guide plate 2. According to some embodiments, the material of the adhesion unit 4 may comprise a transparent material. According to some embodiments, the material of the adhesion unit 4 may comprise an acrylic polymer or other suitable material. According to some embodiments, the adhesion unit 4 may be non-light curing glue (for example, non-UV curing glue); but the present disclosure is not limited thereto. According to some embodiments, the loss modulus of the adhesion unit 4 at 30° C. is greater than or equal to 15 Kpa and less than or equal to 200 Kpa; but the present disclosure is not limited thereto. According to some embodiments, the loss modulus of the adhesion unit 4 at 30° C. is greater than or equal to 20 Kpa and less than or equal to 165 Kpa; but the present disclosure is not limited thereto.

The present disclosure uses a dynamic mechanical analyzer (DMA) to measure the parameters of the adhesion unit material to obtain the loss tangent (tan δ), the loss modulus and the storage modulus. The relationship between the three parameters of the loss tangent, the loss modulus and the storage modulus is as follows.

Loss tangent(tan δ)=loss modulus/storage modulus

Through designing the range of the above-mentioned storage modulus, loss modulus and/or loss tangent of the adhesion unit 4, the probability of the adhesion unit 4 filling the recessed structure of the light guide plate can be reduced. Thus, the probability that the light guide effect of the light guide plate affected by the filling of the adhesion unit 4, which may affect the light guide effect and cause the images darkened, can be reduced.

In some embodiments, the adhesion unit 4 comprises a composite layer, for example, comprising a first layer (not shown in the figure) and a second layer (not shown in the figure) disposed on the first layer (not shown in the figure), wherein the first layer (not shown in the figure) is a layer contacting the second surface 2b of the light guide plate 2, and the loss tangent of the first layer (not shown in the figure) at 30° C. is less than the loss tangent of the second layer (not shown in the figure) at 30° C. Thus, not only the light guide effect of the light guide plate 2 can be maintained, but also the adhesion between components can be improved and the optical quality can be increased. In addition, the adhesion affected by the generation of bubbles between components during assembling, which may reduce the optical quality, can be reduced.

In the present disclosure, the material of the adhesion unit 5 and the adhesion unit 10 may respectively comprise polyvinyl butyral (PVB), ethylene vinyl acetate (EVA), optical clear adhesive (OCA), optical clear resin (OCR), other suitable material or a combination thereof; but the present disclosure is not limited thereto. In the present disclosure, the touch layer 6 comprises components such as touch electrodes and conductive lines, and is not described here again. The touch layer 6 can transmit signals to the reflective panel 1 through the user's contact. The touch layer 6 can also be touch glass, touch film or other components with touch functions. According to some embodiments, the materials of the touch electrodes and the conductive lines may comprise a metal or a transparent conductive material. The transparent conductive material may comprise, for example, indium tin oxide (ITO), tin oxide (SnO), zinc oxide (ZnO), indium zinc oxide (IZO), indium gallium zinc oxide (IGZO), indium tin zinc oxide (ITZO), antimony tin oxide (ATO), antimony zinc oxide (AZO), other suitable transparent conductive material or a combination thereof; but the present disclosure is not limited thereto. According to some embodiments, the touch layer 6 may comprise capacitive or resistive touch components. In the present disclosure, the material of the cover substrate 8 may comprise glass, quartz, sapphire, ceramic, polycarbonate (PC), polyimide (PI), polypropylene (PP), polyethylene terephthalate (PET), polymethylmethacrylate (PMMA), other suitable material or a combination thereof; but the present disclosure is not limited thereto. In one embodiment of the present disclosure, the cover substrate 8 may be an anti-glare glass, which can be obtained by surface treating the cover substrate 8. Suitable surface treatments include spraying, coating, chemical etching or a combination thereof; but the present disclosure is not limited thereto. The anti-glare glass can reduce the reflection of light within a specified wavelength range and/or block the entry of light outside the specified wavelength range, thereby increasing the transmittance of light within the specified wavelength range.

In some embodiments, a detection unit (not shown in the figure) may further be included and disposed under the reflective panel 1. The detection unit may comprise resistive detection unit, electromagnetic detection unit, capacitive detection unit or other suitable detection unit; but the present disclosure is not limited thereto. In some embodiments, the detection unit can be used, for example, to detect the position of an input element, such as the contact position or the position of an input signal of an input element such as an electromagnetic pen, stylus pen or laser pen; but the present disclosure is not limited thereto.

In one embodiment of the present disclosure, as shown in FIG. 6, the electronic device may further comprise an anti-reflective layer 9 disposed on the cover substrate 8. The anti-reflective layer 9 is used to reduce the reflection of light in a specified wavelength range and/or block the entry of light outside the specified wavelength range, so as to increase the transmittance of light in the specified wavelength range.

FIG. 7 is a schematic view showing an electronic device according to one embodiment of the present disclosure. The electronic device shown in FIG. 7 is similar to that shown in FIG. 6, except for the following differences.

In one embodiment of the present disclosure, as shown in FIG. 7, the electronic device may comprise: a reflective panel 1; a touch layer 6 disposed on the reflective panel 1; an adhesion unit 5 disposed between the touch layer 6 and the reflective panel 1; a light guide plate 2 disposed on the touch layer 6, wherein the touch layer 6 is disposed between the reflective panel 1 and the light guide plate 2; a light source 3 disposed adjacent to the light guide plate 2; an adhesion unit 7 disposed between the light guide plate 2 and the touch layer 6; a cover substrate 8 disposed on the light guide plate 2; and an adhesion unit 4 disposed between the cover substrate 8 and the light guide plate 2. By combining with the touch layer 6, the electronic device of the present disclosure may be, but is not limited to, for example, a touch display device.

In the present disclosure, the reflective panel 1, the light source 3, the adhesion unit 4, the adhesion unit 5, the touch layer 6 and the cover substrate 8 may be as described above, and are not described again here. In the present disclosure, the light guide plate 2 may be, for example, any one shown in FIG. 1, and FIG. 3 to FIG. 5, and is not described again here. In the present disclosure, the material of the adhesion unit 7 may comprise polyvinyl butyral (PVB), ethylene vinyl acetate (EVA), optical clear adhesive (OCA), optical clear resin (OCR), other suitable material or a combination thereof; but the present disclosure is not limited thereto.

In one embodiment of the present disclosure, as shown in FIG. 7, the electronic device may further comprise an anti-reflective layer 9 disposed on the cover substrate 8. The anti-reflective layer 9 may be used to reduce the reflection of light in a specified wavelength range and/or block the entry of light outside the specified wavelength range, so as to increase the transmittance of light in the specified wavelength range.

In the present disclosure, by using the light guide plate 2 with specific design, the light guide efficiency of the light guide plate 2 can be improved, thereby improving the display quality of the electronic device or reducing glare.

The above specific embodiments should be construed as illustrative only and not in any way limiting of the remainder of the present disclosure.

Although the present disclosure has been explained in relation to its embodiment, it is to be understood that many other possible modifications and variations can be made without departing from the spirit and scope of the disclosure as hereinafter claimed.

1. An electronic device, comprising:
a reflective panel;
a light guide plate disposed on the reflective panel, wherein the light guide plate has a first surface, a second surface opposite to the first surface, and a side surface connecting between the first surface and the second surface, wherein the first surface is adjacent to the reflective panel; and
a light source adjacent to the side surface,
wherein the second surface comprises a plurality of recessed structures, one of the plurality of recessed structures has a depth in a normal direction of the reflective panel, the side surface has a thickness, and a ratio of the depth to the thickness is greater than or equal to 0.0001 and less than or equal to 0.25;
wherein after light emitted by the light source passes through the light guide plate, a first light pattern is measured from the first surface, and a second light pattern is measured from the second surface, wherein a maximum ratio of brightness of the first light pattern to brightness of the second light pattern is located at a view angle greater than or equal to 0° and less than or equal to 40°.

2. The electronic device of claim 1, wherein a ratio of the brightness of the first light pattern to the brightness of the second light pattern is greater than or equal to 5 at the view angle between 10° to 30°.

3. The electronic device of claim 1, wherein the plurality of recessed structures respectively have a concave surface connecting to a planar surface of the second surface, wherein in a cross-section of the light guide plate, the concave surface comprises a first side and a second side, an angle included between the first side and a virtual surface perpendicular to the planar surface is a first angle, an angle included between the second side and the virtual surface is a second angle, and the first angle is greater than the second angle.

4. The electronic device of claim 3, wherein the first angle is greater than or equal to 45° and less than or equal to 70°, and the second angle is greater than or equal to 0° and less than or equal to 45°.

5. The electronic device of claim 3, wherein a sum of the first angle and the second angle is greater than or equal to 50° and less than or equal to 115°.

6. The electronic device of claim 1, wherein the plurality of recessed structures respectively a concave surface connecting a planar surface of the second surface, wherein in a cross-section of the light guide plate, the concave surface comprise a first side and a second side, an angle included between the first side and an extension surface of the planar surface is a third angle, an angle included between the second side and the extension surface is a fourth angle, and the third angle is less than the fourth angle.

7. The electronic device of claim 1, wherein the reflective panel comprises a first panel, a second panel and a third panel, the second panel is disposed between the first panel and the third panel, and the first panel, the second panel and the third panel reflect light with different colors respectively.

8. The electronic device of claim 1, wherein the depth of the one of the plurality of recessed structures is between 0.5 μm and 30 μm.

9. The electronic device of claim 1, wherein a width of the one of the plurality of recessed structures is between 5 μm and 150 μm.

10. The electronic device of claim 1, wherein a ratio of the depth of the one of the plurality of recessed structures to a width of the one of the plurality of recessed structures is between 0.003 and 6.

11. An electronic device, comprising:
a reflective panel;
a light guide plate disposed on the reflective panel, wherein the light guide plate has a first surface, a second surface opposite to the first surface, and a side surface connecting between the first surface and the second surface, wherein the first surface is adjacent to the reflective panel; and
a light source adjacent to the side surface,
wherein the second surface comprises a plurality of recessed structures, one of the plurality of recessed structures has a depth in a normal direction of the reflective panel, the side surface has a thickness, and a ratio of the depth to the thickness is greater than or equal to 0.0001 and less than or equal to 0.25;
wherein after light emitted by the light source passes through the light guide plate, a first light pattern is measured from the first surface, a ratio of brightness of the first light pattern at a view angle of 0° to a maximum brightness of the first light pattern ranges from 0.05 to 0.4.

12. The electronic device of claim 11, wherein after light emitted by the light source passes through the light guide plate, a second light pattern is measured from the second surface, wherein a ratio of brightness of the first light pattern to brightness of the second light pattern at a view angle between 10° and 30° is greater than or equal to 5.

13. The electronic device of claim 11, wherein the plurality of recessed structures respectively have a concave surface connecting to a planar surface of the second surface, wherein in a cross-section of the light guide plate, the concave surface comprises a first side and a second side, an angle included between the first side and a virtual surface perpendicular to the planar surface is a first angle, an angle included between the second side and the virtual surface is a second angle, and the first angle is greater than the second angle.

14. The electronic device of claim 13, wherein the first angle is greater than or equal to 45° and less than or equal to 70°, and the second angle is greater than or equal to 0° and less than or equal to 45°.

15. The electronic device of claim 13, wherein a sum of the first angle and the second angle is greater than or equal to 50° and less than or equal to 115°.

16. The electronic device of claim 11, wherein the plurality of recessed structures respectively a concave surface connecting a planar surface of the second surface, wherein in a cross-section of the light guide plate, the concave surface comprise a first side and a second side, an angle included between the first side and an extension surface of the planar surface is a third angle, an angle included between the second side and the extension surface is a fourth angle, and the third angle is less than the fourth angle.

17. The electronic device of claim 11, wherein the reflective panel comprises a first panel, a second panel and a third panel, the second panel is disposed between the first panel and the third panel, and the first panel, the second panel and the third panel reflect light with different colors respectively.

18. The electronic device of claim 11, wherein the depth of the one of the plurality of recessed structures is between 0.5 μm and 30 μm.

19. The electronic device of claim 11, wherein a width of the one of the plurality of recessed structures is between 5 μm and 150 μm.

20. The electronic device of claim 11, wherein a ratio of the depth of the one of the plurality of recessed structures to a width of the one of the plurality of recessed structures is between 0.003 and 6.
